(19) United States
(12) Patent Application Publication
(10) Pub. No.: US 2026/0101088 A1
(43) Pub. Date: Apr. 9, 2026

(54) METHODS, SYSTEMS, AND MEDIA FOR AI BASED INTERACTIVE CONTENT DELIVERY SYSTEM

(71) Applicant: Nicholas J. Schreiber, Sanford, FL (US)

(72) Inventor: Nicholas J. Schreiber, Sanford, FL (US)

(21) Appl. No.: 19/348,692

(22) Filed: Oct. 2, 2025

Related U.S. Application Data
(60) Provisional application No. 63/678,598, filed on Aug. 2, 2024.

(51) Int. Cl. H04N 21/466; H04N 21/254; H04N 21/44; H04N 21/472; H04N 21/478

(52) U.S. Cl. CPC H04N 21/4668; H04N 21/2542; H04N 21/44008; H04N 21/47217; H04N 21/47815

(57) ABSTRACT

A system for AI-based interactive content delivery may comprise memory and one or more processors operably coupled to the memory. The one or more processors may be configured to store a plurality of content items. The processors may provide at least a first portion of a first video to a first computer vision model that may be configured to identify a first plurality of features in the first video based at least on the first portion of the first video. The first portion of the first video may be associated with at least a first playback position in the first video. The processors may generate at least one feature vector based at least on the first plurality of features. The processors may provide the at least one feature vector to a machine learning model that may be configured to recommend at least one content item of the plurality of content items based at least on the at least one feature vector. During playback of the first video at a first user device, the processors may determine that the first playback position in the first video was reached. In response to determining that the first playback position in the first video was reached, the processors may cause the recommended at least one content item to be presented at a second user device. The first user device may be different from the second user device.

### CROSS-REFERENCE TO RELATED APPLICATIONS

This application claims the benefit of priority to U.S. Provisional Application No. 63/678,598, filed Aug. 2, 2024, which is incorporated herein by reference in its entirety.

### TECHNICAL FIELD

The present disclosure relates to methods, systems, and media for interactive content delivery. More particularly, certain embodiments relate to methods, systems, and media for artificial intelligence-based interactive content delivery utilizing computer vision models and machine learning algorithms for multi-device content synchronization and recommendation.

### BACKGROUND

The following background information is provided to assist the reader in understanding the technology described below and the environment in which it may typically be used. The terms used herein are not intended to be limited to any particular narrow interpretation unless clearly stated otherwise in this document. Traditional linear and static content delivery systems have historically limited user engagement to passive consumption experiences. Such systems typically fail to provide interactive and immersive experiences that may enhance user engagement. Generic recommendation algorithms commonly implemented in existing systems may fail to offer personalized content suggestions that are contextually relevant to specific portions of video content being consumed. This may result in less relevant content discovery and reduced user satisfaction.

Furthermore, conventional content delivery systems often lack built-in social features, which may force viewers to use external platforms for discussion and sharing. This fragmentation may negatively impact the overall viewing experience and may reduce community engagement around content. There exists a need in the art for improved methods, systems, and media for AI-based interactive content delivery that can provide non-linear, dynamic content delivery with more personalized content suggestions. Such systems may beneficially include built-in social features for increased user engagement and may provide synchronized multi-device experiences that enhance traditional content consumption. The above background information is provided for the purpose of making known information believed by the applicant to be of possible relevance to the present disclosure. No admission is necessarily intended, nor should be construed, that any of the preceding information constitutes prior art against the present disclosure.

### BRIEF SUMMARY

This summary is provided to introduce a selection of concepts in a simplified form that are further described in the detailed description below. This summary is not intended to identify key features or essential features of the claimed subject matter, nor is it intended to be used to limit the scope of the claimed subject matter. The following summary merely presents some concepts of the disclosure in a simplified form as a prelude to the more detailed description provided below.

According to one aspect, a system for AI-based interactive content delivery may include memory and one or more processors operably coupled to the memory. The one or more processors may be configured to store a plurality of content items and provide at least a first portion of a first video to a first computer vision model. The first computer vision model may be configured to identify a first plurality of features in the first video based at least on the first portion of the first video. The first portion of the first video may be associated with at least a first playback position in the first video. The one or more processors may be further configured to generate at least one feature vector based at least on the first plurality of features and provide the at least one feature vector to a machine learning model. The machine learning model may be configured to recommend at least one content item of the plurality of content items based at least on the at least one feature vector. During playback of the first video at a first user device, the one or more processors may be configured to determine that the first playback position in the first video was reached. In response to determining that the first playback position in the first video was reached, the one or more processors may be configured to cause the recommended at least one content item to be presented at a second user device, wherein the first user device is different from the second user device.

According to another aspect, a method for AI-based interactive content delivery may include storing a plurality of content items and providing at least a first portion of a first video to a first computer vision model. The first computer vision model may be configured to identify a first plurality of features in the first video based at least on the first portion of the first video. The first portion of the first video may be associated with at least a first playback position in the first video. The method may further include generating at least one feature vector based at least on the first plurality of features and providing the at least one feature vector to a machine learning model. The machine learning model may be configured to recommend at least one content item of the plurality of content items based at least on the at least one feature vector. During playback of the first video at a first user device, the method may include determining that the first playback position in the first video was reached. In response to determining that the first playback position in the first video was reached, the method may include causing the recommended at least one content item to be presented at a second user device, wherein the first user device is different from the second user device.

According to yet another aspect, a non-transitory computer-readable medium may include instructions that, when executed by one or more processors, cause the one or more processors to perform operations for interactive content delivery. The operations may include storing a plurality of content items and receiving playback data indicating at least a first playback position in a first video. During playback of the first video at a first user device, the operations may include determining that the first playback position in the first video was reached. In response to determining that the first playback position in the first video was reached, the operations may include causing at least one content item of the plurality of content items to be presented at a second user device, wherein the first user device is different from the second user device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become apparent from the following description and appended claims, taken in conjunction with the accompanying drawings. Understanding that these drawings depict only several embodiments in accordance with the disclosure and are therefore not to be considered limiting of its scope, the disclosure will be described with additional specificity and detail through use of the accompanying drawings.

FIG. 1 illustrates a block diagram of a system for content delivery, according to some embodiments disclosed herein.

FIG. 2 illustrates a block diagram of a computing device for content delivery, according to some embodiments disclosed herein.

FIG. 3 illustrates an example diagram of a content management system for content delivery, according to some embodiments disclosed herein.

FIG. 4 illustrates an example diagram of a case file portal for content delivery, according to some embodiments disclosed herein.

FIG. 5 illustrates an example diagram of community integration for content delivery, according to some embodiments disclosed herein.

FIG. 6 illustrates an example diagram of grouping content for content delivery, according to some embodiments disclosed herein.

FIG. 7 illustrates an example diagram of interacting with content, according to some embodiments disclosed herein.

FIG. 8 illustrates an example diagram of a production portal for content delivery, according to some embodiments disclosed herein.

FIG. 9 illustrates an interactive timeline interface for content delivery, according to some embodiments disclosed herein.

FIG. 10 illustrates a user interface element configuration for content delivery, according to some embodiments disclosed herein.

FIG. 11 illustrates a computing system architecture with specialized processing modules for content delivery, according to some embodiments disclosed herein.

The drawings are not necessarily to scale. Certain features and certain views of the drawings may be shown exaggerated in scale or in schematic in the interest of clarity and conciseness. The drawings illustrate generally, by way of example, but not by way of limitation, various embodiments discussed in the present document.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated and form part of this disclosure.

The present disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior disclosure.

As used herein, the term “comprising” means “including, but not limited to.” As used herein, the term “consisting of” means “including and limited to.” As used herein, the term “consisting essentially of” means that the composition, method or structure may include additional elements, steps and/or ingredients, but only if the additional elements, steps and/or ingredients do not materially alter the basic and novel characteristics of the claimed composition, method or structure.

The embodiments and examples described herein are for illustrative purposes only and various modifications or changes in light thereof will be suggested to persons skilled in the art and are to be included within the spirit and purview of this application and scope of the appended claims.

Mechanisms for interactive content delivery are disclosed herein. The mechanisms described herein may be implemented as systems, methods, media, or any combination thereof. The mechanisms may provide AI-based interactive content delivery that transforms traditional linear video consumption into dynamic, multi-device interactive experiences. The disclosed mechanisms may utilize computer vision models and machine learning algorithms to analyze video content in real-time, extract features, and deliver contextually relevant interactive content to companion devices during video playback.

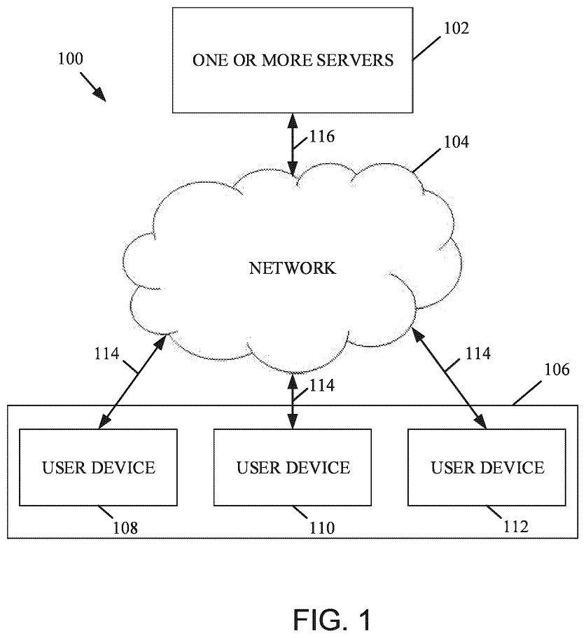

Referring to FIG. 1, a system 100 for interactive content delivery may be used with some embodiments disclosed herein. System 100 may include one or more servers 102, a network 104, one or more user devices 106, or any combination thereof. The one or more user devices 106 may include a first user device 108, a second user device 110, a third user device 112, or any combination thereof. The one or more servers 102 may be any suitable server or servers for storing data, programs, or a combination thereof, for interactive content delivery. The one or more servers 102 may store any suitable data about user accounts, video content, user preferences, user engagement, historical user data, content items, or any combination thereof. Content items may include audio content items, visual content items, video content items, images, videos, polls, trivia questions, games, or any combination thereof.

Regarding FIG. 1, the one or more servers 102 may include one or more computing devices. While the one or more servers 102 are illustrated as one device in FIG. 1, the processes performed by the one or more servers 102 may be performed by any suitable number of computing devices in some embodiments. The one or more user devices 106 may be any suitable user device or devices for storing data, programs, or a combination thereof, for interactive content delivery. The one or more user devices 106 may store any suitable data about user accounts, video content, user preferences, user engagement, historical user data, content items, or any combination thereof. Content items may include audio content items, visual content items, video content items, images, polls, trivia questions, games, or any combination thereof.

Regarding FIG. 1, the one or more user devices 106 may include one or more computing devices. Although three user devices 108, 110, 112 are shown in FIG. 1, any suitable number of user devices may be used in some embodiments. The first user device 108 may serve as a primary viewing device for displaying video content. The second user device 110 may serve as a secondary interactive device for presenting interactive content items synchronized with the video playback on the first user device 108. The third user device 112 may provide additional interactive capabilities or may serve as an alternative primary or secondary device. The network 104 may include a wired network, a wireless network, or a combination thereof. The network 104 may include the Internet, an intranet, a wide area network (WAN), a local-area network (LAN), a digital subscriber line (DSL) network, a frame relay network, an asynchronous transfer mode (ATM) network, a virtual private network (VPN), any other suitable communication network, or any combination thereof. One or more communications links 114 may connect the one or more user devices 106 to the network 104. One or more communication links 116 may connect the network 104 to the one or more servers 102. The one or more communication links 114, 116 may be any communication links suitable for communicating information between the one or more user devices 106 and the one or more servers 102, such as network links, dial-up links, wireless links, hard-wired links, any other suitable communications links, or any combination thereof. The one or more servers 102 and the one or more user devices 106 may be implemented using any suitable hardware. Any device of the one or more servers 102 and the one or more user devices 106 may be implemented using any suitable general-purpose computer or special-purpose computer. Any general-purpose computer or special-purpose computer may include any suitable hardware.

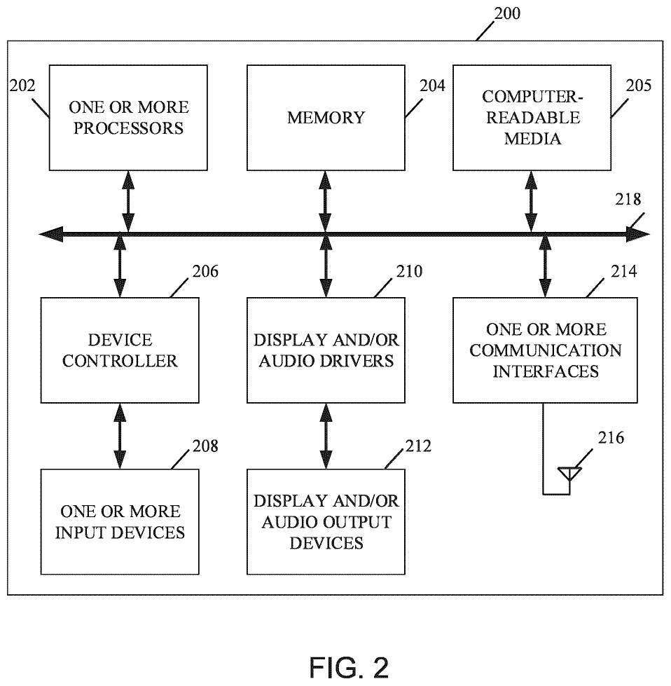

Referring to FIG. 2, in one or more embodiments, an example hardware configuration of a computing device 200 is illustrated. The computing device 200 may include one or more processors 202, memory 204, a device controller 206, one or more input devices 208, display and/or audio drivers 210, display and/or audio output devices 212, one or more communication interfaces 214, one or more antennas 216, a bus 218, or any combination thereof. The computing device 200 may also include computer-readable media 205 operably coupled to the one or more processors 202. The one or more processors 202 may include any suitable hardware processor, such as a central processing unit (CPU), a graphics processing unit (GPU), a tensor processing unit (TPU), an accelerated processing unit (APU), any other type of processing unit, or any combination thereof. The one or more processors 202 may include a microprocessor, a micro-controller, a digital signal processor, dedicated logic, an application-specific integrated circuit (ASIC), a field programmable gate array (FPGA), an accelerator, any other suitable circuitry for controlling the functioning of a general purpose computer or a special purpose computer, or any combination thereof. The one or more processors 202 may be particularly configured for executing computer vision models, speech recognition models, and machine learning algorithms as described herein.

Regarding FIG. 2, one or more processors 202 of any server of the one or more servers 102 may be controlled by a server program stored in memory 204 of the server. The server program may cause the one or more processors 202 to perform any process or subprocess disclosed herein. One or more processors 202 of any user device of the one or more user devices 106 may be controlled by a computer program stored in memory 204 of the user device. The computer program may cause the one or more processors 202 to perform any process or subprocess disclosed herein. In one or more embodiments, the memory 204 may include any suitable memory, storage, or a combination thereof for storing programs, data, and/or any other suitable information. Memory 204 may include volatile memory, non-volatile memory, or any combination thereof. Memory 204 may include random access memory, read-only memory, flash memory, a hard disk drive, a solid state drive, optical media, any other suitable memory, or any combination thereof.

In one or more embodiments, computer-readable media 205 may be operably coupled to the one or more processors 202. Computer-readable media 205 may store instructions that, when executed by the one or more processors 202, cause the one or more processors 202 to perform any process or subprocess disclosed herein. Computer readable media 205 may be transitory or non-transitory. Non-transitory computer readable media may include media such as magnetic media, optical media, semiconductor media, any suitable media that is not fleeting or devoid of any semblance of permanence during transmission, and/or any suitable tangible media. Transitory computer readable media may include signals on networks, in wires, conductors, optical fibers, circuits, any suitable media that is fleeting and devoid of any semblance of permanence during transmission, and/or any suitable intangible media.

In one or more embodiments, the device controller 206 may include any suitable processor or circuitry for controlling and receiving any input from the one or more input devices 208. The one or more input devices 208 may include a touchscreen, a keyboard, a mouse, one or more buttons, a voice recognition circuit, a camera, one or more sensors, any other suitable input device, or any combination thereof. The one or more sensors may include one or more accelerometers, one or more gyroscope sensors, one or more microphones, any other suitable sensors, or any combination thereof. In one or more embodiments, the display and/or audio drivers 210 may include any suitable circuitry for controlling and driving output to one or more display and/or audio output devices 212. The display and/or audio output devices 212 may include a display, one or more speakers, or a combination thereof. The display may include a touchscreen, a flat-panel display, a cathode ray tube display, a projector, any other suitable display or presentation device, or any combination thereof.

In one or more embodiments, the one or more communication interfaces 214 may include any suitable circuitry for interfacing with one or more communication networks, such as network 104. The one or more communication interfaces 214 may include network interface card circuitry, wired communication circuitry, wireless communication circuitry, any other suitable communication network circuitry, or any combination thereof. In one or more embodiments, the one or more antennas 216 may wirelessly communicate with a communication network such as network 104. The one or more antennas 216 may be omitted in some embodiments. In one or more embodiments, the bus 218 may include any suitable communication system for communicating data, addresses, control signals, power, or any combination thereof, between components 202, 204, 205, 206, 210, and 214. The bus 218 may include any suitable conductors that are constructed and arranged to communicate data, addresses, control signals, power, or any combination thereof, between the components.

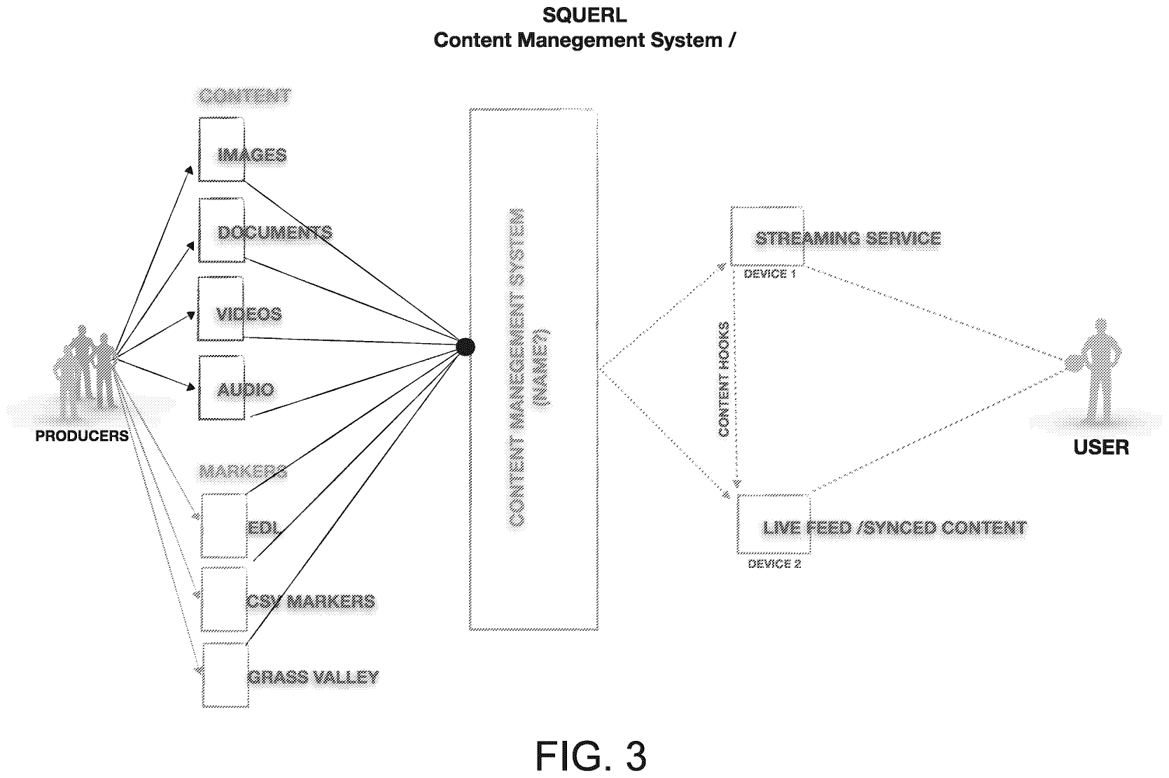

Referring to FIG. 3, an example diagram of a content management system is illustrated. The content management system may receive various types of content from producers, including images, documentaries, videos, audio, markers, SDI, and Grass Valley inputs. The content management system may process and organize this content for distribution to users through multiple services, including streaming services and live feed/synced content delivery. Content hooks may provide integration between different services to enable synchronized interactive experiences.

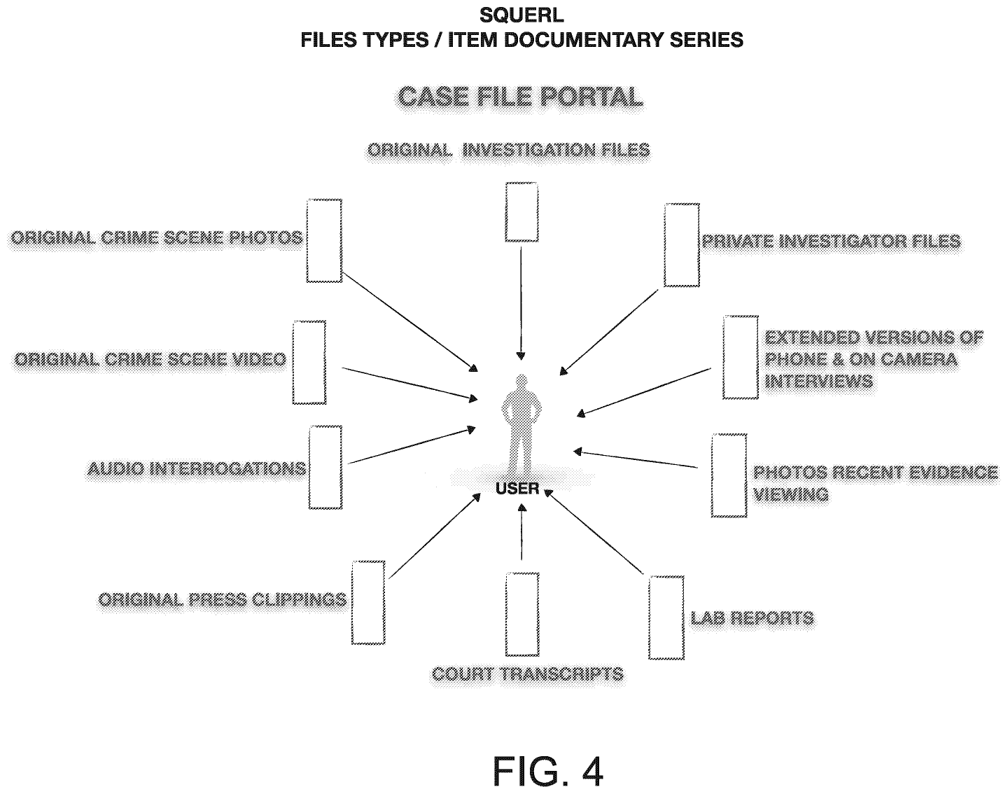

Referring to FIG. 4, an example diagram of a case file portal is illustrated. The case file portal may provide users with access to various types of documentary-related files, including private investigator files, extended versions of photos and interviews, recent evidence photos, lab reports, court transcripts, original press clippings, audio interrogations, original crime scene videos, original crime scene photos, and original investigation files. This comprehensive access may enhance the interactive content delivery experience by providing contextual background materials.

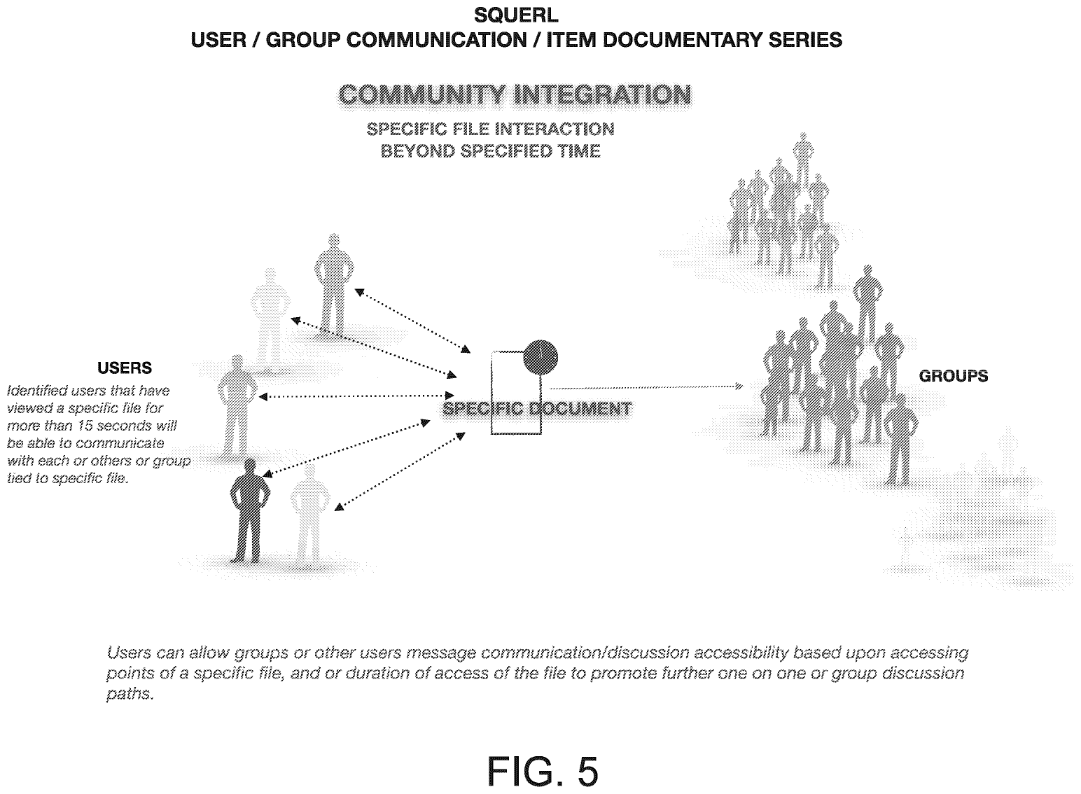

Referring to FIG. 5, an example diagram of community integration is illustrated. The community integration system may enable users and groups to communicate and discuss specific documents or content items. Users may be assigned to document-based groups for focused communication. The system may track user access patterns and engagement to facilitate meaningful discussions around specific content elements. FIG. 5 illustrates a community integration system 500 that facilitates user and group communication around specific documents or content items within the interactive content delivery framework. The community integration system 500 may enable users to engage in document-based discussions and form groups based on shared access to particular content elements.

In one or more embodiments, the community integration system 500 may include users 502 represented as individual entities who may access specific documents or content items. Users 502 may be part of one or more groups, may maintain active or inactive status, and may originate from different groups while accessing the same content item. The system 500 may track individual user access patterns and engagement levels to facilitate meaningful interactions. A specific document 504 may serve as a central node within the community integration system 500. The specific document 504 may represent any content item, file, or interactive element that users 502 may access during video playback or through the content delivery system. The specific document 504 may be associated with particular playback positions, content segments, or thematic elements within the primary video content. Groups 506 may represent collections of users who may be organized around shared interests, access patterns, or content engagement behaviors. Groups 506 may be formed automatically based on user interactions with the specific document 504, or may be manually created by users or system administrators. The groups 506 may provide a framework for focused communication and discussion around particular content elements.

In one or more embodiments, the community integration system 500 may establish communication pathways between users 502 and the specific document 504 through bidirectional connections. These connections may enable users 502 to access, interact with, and provide feedback on the specific document 504. The system 500 may track the duration of access, specific interaction points, and engagement levels for each user 502 with respect to the specific document 504. In one or more embodiments, communication pathways may also exist between the specific document 504 and groups 506. These pathways may enable group-level access to the specific document 504 and may facilitate collective discussions or collaborative interactions around the content. The system 500 may manage group permissions and access controls to ensure appropriate content sharing and discussion moderation.

In one or more embodiments, the community integration system 500 may allow users 502 to enable message communication and discussion accessibility based on associating specific points within the specific document 504. Users 502 may configure their communication preferences to allow interaction with other users or groups who have accessed the same content elements. The system 500 may promote further one-on-one or group discussion by identifying common access points and shared interests among users 502.

In one or more embodiments, the system 500 may implement access duration tracking to determine how long users 502 interact with the specific document 504. This duration data may be used to identify highly engaged users who may be suitable candidates for group formation or discussion leadership roles. The system 500 may also use access duration as a metric for determining content relevance and user engagement levels. In one or more embodiments, document-based group communication may be facilitated through the community integration system 500. Users 502 may be assigned to document-based groups based on their interaction patterns with the specific document 504. These groups may provide focused communication channels that center around particular content elements, themes, or discussion topics related to the specific document 504. In one or more embodiments, the community integration system 500 may enable temporal segmentation of user interactions, allowing for time-based grouping and discussion organization. Users 502 who access the specific document 504 during similar time periods or at synchronized playback positions may be grouped together for enhanced collaborative experiences.

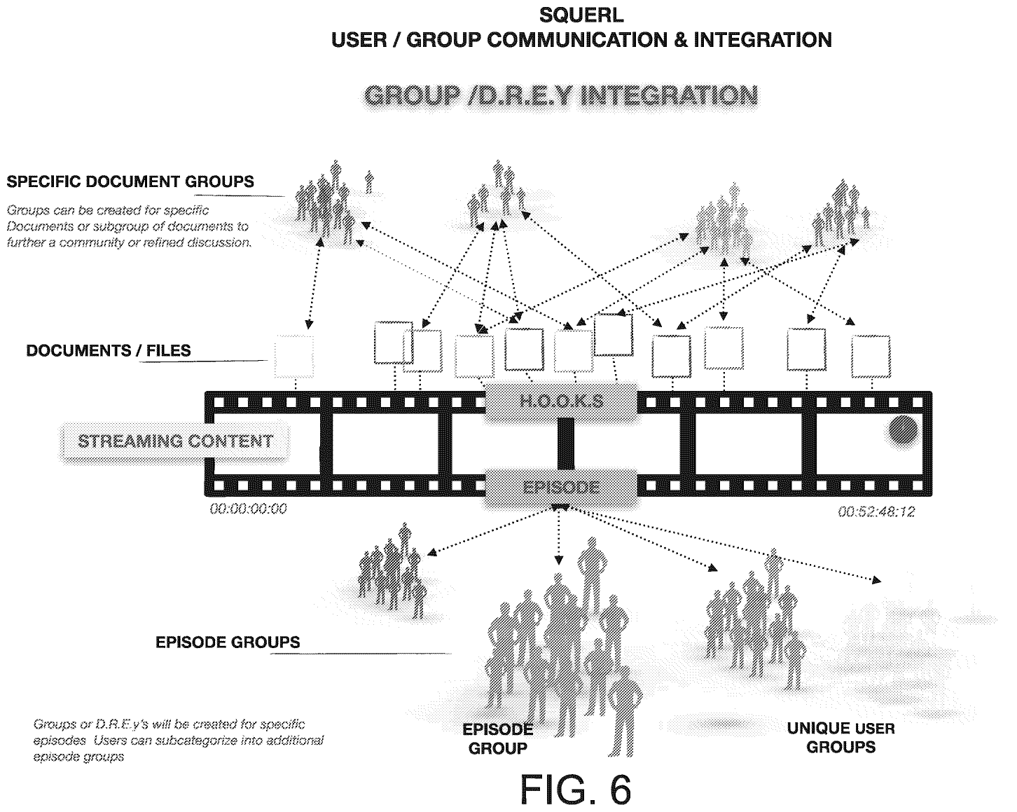

Referring to FIG. 6, an example diagram of grouping content is illustrated. The system may organize content into various group types, including document/file-based groups, episode groups, and unique user groups. Content may be temporally segmented to enable time-based group interactions. The system may utilize hooks to integrate streaming content with episode-specific group communications. FIG. 6 illustrates a comprehensive content grouping system 600 that may organize various types of content and user interactions within the interactive content delivery framework. The system 600 may enable temporal segmentation of content and may facilitate group-based communication around specific content elements.

In one or more embodiments, the content grouping system 600 may include a filmstrip representation that may visually organize different content types and their associated temporal markers. The filmstrip may include a documents/files section that may represent document-based content elements accessible to users during video playback. The documents/files section may be associated with specific document groups 602 that may enable focused communication around particular content items. In one or more embodiments, a streaming content section may represent the primary video content being delivered to users through the interactive content delivery system. The streaming content section may be positioned along the filmstrip timeline and may be associated with specific playback positions and temporal markers. Timecode markers may indicate specific positions within the streaming content where interactive elements or group communications may be triggered.

In one or more embodiments, the system 600 may include a central hooks component that may serve as an integration point between different content types and user groups. The hooks component may facilitate the connection between streaming content and episode-specific group communications. The hooks component may enable the synchronization of interactive content delivery with specific temporal positions within the primary video content. In one or more embodiments, an episode section may represent discrete content segments that may be associated with particular user groups and communication channels. The episode section may be linked to episode groups 604 that may provide focused discussion forums around specific content episodes or segments.

In one or more embodiments, the content grouping system 600 may support specific document groups 602 that may enable document-based or file-based group communication. Users may be assigned to document-based groups based on their access patterns or interactions with specific content items. The specific document groups 602 may provide focused communication channels that may center around particular documents, files, or interactive content elements. In one or more embodiments, episode groups 604 may represent collections of users who may be organized around specific episodes or content segments. The episode groups 604 may be temporally segmented to enable time-based group interactions and discussions. Users within episode groups 604 may engage in synchronized communication during specific playback periods or may access group discussions related to particular episode content.

In one or more embodiments, the system 600 may also include unique user groups 606 that may represent specialized collections of users based on particular criteria or access patterns. The unique user groups 606 may provide alternative grouping mechanisms that may complement the document-based and episode-based group structures. In one or more embodiments, the content grouping system 600 may enable temporal segmentation of user interactions and group communications. The temporal segmentation may allow users to be grouped based on their access timing, playback positions, or synchronized viewing patterns. This temporal organization may enhance collaborative viewing experiences and may enable real-time group discussions around specific content moments.

In one or more embodiments, the filmstrip representation may serve as a visual timeline that may organize content elements, user groups, and temporal markers within a unified interface. The filmstrip may provide a chronological framework for understanding how different content types and user interactions may be coordinated throughout the video playback experience. In one or more embodiments, the integration between streaming content and group communications may be facilitated through the hooks component, which may coordinate the delivery of interactive content with group-based discussions and user communications. This integration may enable seamless transitions between passive video consumption and active group engagement around specific content elements.

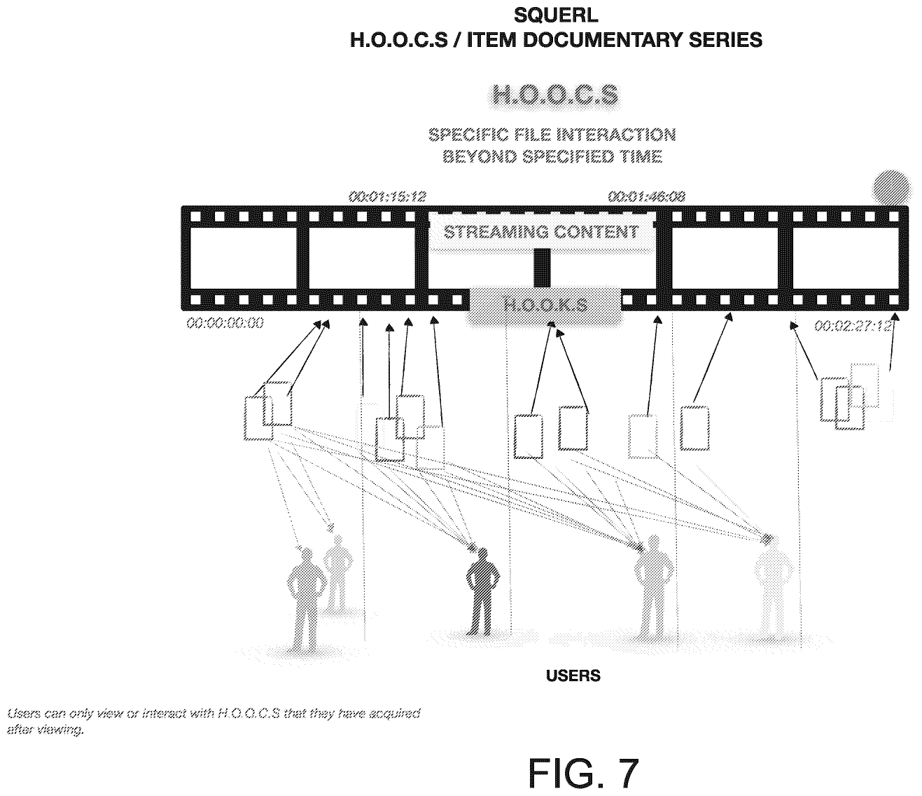

Referring to FIG. 7, an example diagram of interacting with content is illustrated. The system may enable users to interact with specific content items beyond specified time periods. Users may access interactive content items (H.O.O.C.S.) after acquiring prerequisite knowledge or meeting certain criteria. The system may track user progress and enable progressive access to content based on engagement levels. FIG. 7 illustrates a comprehensive system for specific file interaction beyond specified time periods within the interactive content delivery framework. The diagram may demonstrate how users may access interactive content items after meeting predetermined criteria or acquiring prerequisite knowledge.

In one or more embodiments, the central filmstrip representation may display a temporal sequence of content segments including H.O.O.C.S. items and streaming content sections. Each segment may be associated with specific numerical identifiers. These identifiers may represent unique content markers, timestamps, or access codes that may enable system tracking and user progression monitoring. In one or more embodiments, the H.O.O.C.S. segments may represent interactive content items that may be accessible only after users have acquired specific knowledge or completed certain engagement requirements. The streaming content section may represent the primary video content that may serve as the foundation for the interactive experience. The alternating arrangement of H.O.O.C.S. and streaming content segments may indicate a structured progression where users may advance through different levels of interactive content based on their engagement and knowledge acquisition.

In one or more embodiments, user icons positioned on the right side of the diagram may represent individual users who may interact with the system. Each user icon may be connected through dotted lines to small rectangular boxes, which may represent user-specific access permissions or interaction states. These boxes may be connected through arrows and lines to specific segments of the filmstrip, indicating that users may have different levels of access to various content elements based on their progression through the system. In one or more embodiments, the system may implement a knowledge-based access control mechanism where users may only view or interact with H.O.O.C.S. items after they have acquired the necessary knowledge or completed prerequisite activities. This progressive access model may enhance user engagement by creating a structured learning experience where advanced interactive content may be unlocked as users demonstrate comprehension or engagement with earlier content segments.

In one or more embodiments, the temporal aspect of the system may allow users to access interactive content items beyond the specified time periods of the original video playback. This extended access may enable users to revisit and interact with content elements at their own pace, potentially after the primary video viewing session has concluded. The system may track user progress and maintain access permissions to ensure that users may only interact with content for which they have met the necessary requirements. In one or more embodiments, the connection pathways between users and content segments may indicate that different users may have varying levels of access to the same content elements based on their individual progression through the system. This personalized access model may ensure that interactive content delivery may be tailored to each user's knowledge level and engagement history.

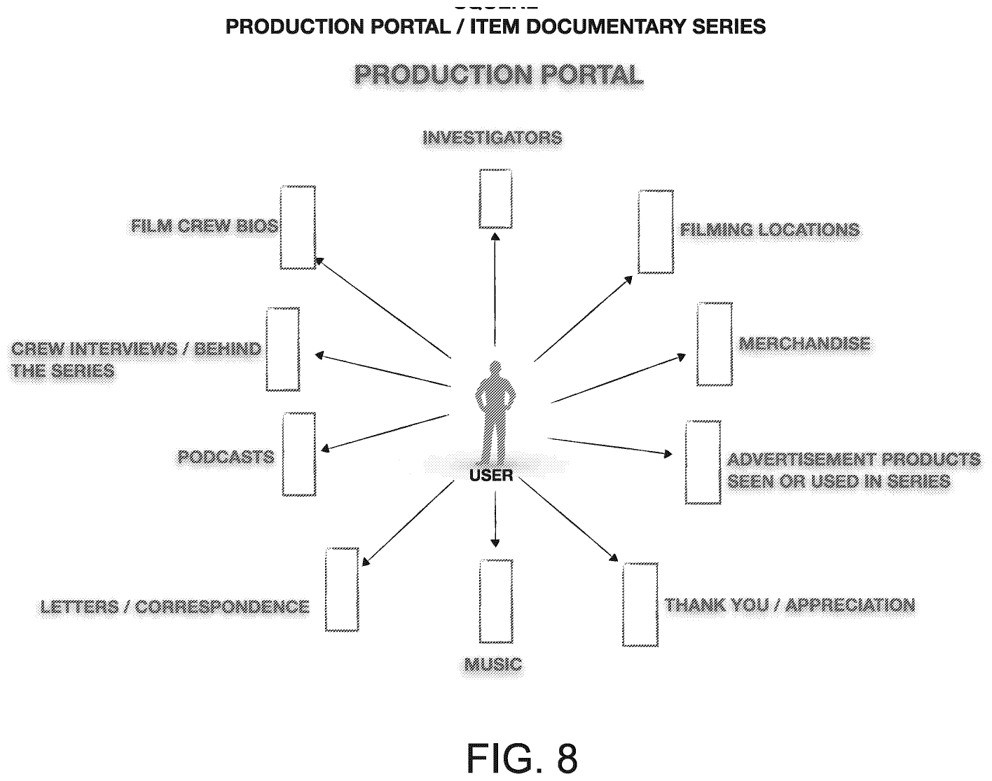

Referring to FIG. 8, an example diagram of a production portal is illustrated. The production portal may provide users with access to various production-related content, including investigator information, filming locations, merchandise, advertisement products, appreciation messages, music, letters/correspondence, podcasts, crew interviews, and film crew blogs. This comprehensive access may enhance user engagement with the production process and behind-the-scenes content. FIG. 8 illustrates a comprehensive production portal system 800 that may provide users with access to various production-related content elements within the interactive content delivery framework. The production portal may serve as a centralized hub for behind-the-scenes and production-related materials that may enhance user engagement with the primary video content.

In one or more embodiments, the production portal system 800 may include a central user 802 who may serve as the primary access point for all production-related content elements. The user 802 may interact with multiple content categories through bidirectional connections that may enable both content access and user feedback mechanisms. In one or more embodiments, the production portal may provide access to investigators 804 who may be associated with the primary video content. The investigators 804 may include private investigators, law enforcement personnel, or expert consultants who may have contributed to the content creation process. Users may access investigator profiles, interview excerpts, or additional investigative materials that may complement the primary video content.

In one or more embodiments, filming locations 806 may be accessible through the production portal system 800. The filming locations 806 may provide users with geographical information, historical context, or visual materials related to the specific locations where the primary video content was recorded. This location-based content may enhance user understanding of the narrative context and may provide additional immersive elements. In one or more embodiments, merchandise 808 may be available through the production portal system 800. The merchandise 808 may include branded items, collectibles, or products specifically created to accompany the primary video content. The system 800 may integrate with e-commerce platforms to facilitate direct purchasing of merchandise items by users.

In one or more embodiments, advertisement products seen or used in series 810 may be featured within the production portal. These products 810 may represent items that appear within the primary video content and may be available for purchase or further exploration. The system 800 may utilize computer vision models to identify products within the video content and may provide contextual information or purchasing options for these items. In one or more embodiments, thank you or appreciation messages 812 may be accessible through the production portal system 800. These messages 812 may include acknowledgments from content creators, cast members, or production team members. The appreciation messages 812 may provide users with personal connections to the content creation process and may enhance user engagement through direct communication from content creators.

In one or more embodiments, music 814 may be available through the production portal system 800. The music 814 may include soundtrack elements, theme songs, or audio content that may be associated with the primary video content. Users may access music tracks, composer information, or additional audio materials that may enhance their overall content experience. In one or more embodiments, letters or correspondence 816 may be provided through the production portal system 800. The correspondence 816 may include written communications, documents, or textual materials that may be relevant to the primary video content. This written content may provide additional context, background information, or supplementary materials that may deepen user understanding of the subject matter.

In one or more embodiments, podcasts 818 may be accessible through the production portal system 800. The podcasts 818 may include audio discussions, interviews, or commentary that may be related to the primary video content. These audio elements may provide extended discussions, expert analysis, or additional perspectives on the content themes. In one or more embodiments, crew interviews or behind the series content 820 may be available through the production portal system 800. This content 820 may include interviews with production team members, directors, producers, or other personnel involved in the content creation process. The behind-the-scenes content 820 may provide users with insights into the production process and may enhance their appreciation of the content creation efforts.

In one or more embodiments, film crew blog 822 may be accessible through the production portal system 800. The blog 822 may include written entries, updates, or commentary from production team members during the content creation process. The blog content 822 may provide users with real-time or retrospective insights into the production experience and may offer personal perspectives from crew members. In one or more embodiments, the production portal system 800 may implement access control mechanisms to ensure that users may only access content elements for which they have appropriate permissions. The system 800 may track user engagement with different production-related content elements and may use this engagement data to personalize future content recommendations.

In one or more embodiments, the production portal system 800 may integrate with the primary interactive content delivery system to provide synchronized access to production-related materials during video playback. The system 800 may trigger the presentation of specific production content elements at predetermined playback positions within the primary video content. In one or more embodiments, the production portal system 800 may enable users to save, organize, and revisit production-related content elements through a personal library system. Users may create collections of preferred content elements and may share these collections with other users through social features integrated within the portal system.

In one or more embodiments, the system 100 may perform a process for AI-based interactive content delivery. The process may include storing a plurality of content items in memory 204 or on one or more servers 102. The content items may include images, videos, polls, trivia questions, games, audio content, or any combination thereof. In one or more embodiments, the process may include providing at least a first portion of a first video to a first computer vision model. The first computer vision model may be configured to identify a first plurality of features in the first video based at least on the first portion of the first video. The first portion of the first video may be associated with at least a first playback position in the first video. The first computer vision model may include an image recognition model, a facial recognition model, object detection model, scene recognition model, or any combination thereof.

In one or more embodiments, the system 100 may include additional processing capabilities for enhanced content analysis and feature extraction. The processing module 1004 may be configured to apply advanced computer vision techniques including scene classification, temporal action recognition, and multi-modal content understanding. The scene classification functionality may analyze visual elements within video content to identify environmental contexts such as indoor versus outdoor settings, urban versus rural environments, or specific location types. Temporal action recognition may identify and classify human activities or events occurring within video sequences across multiple frames.

In one or more embodiments, the processing module 1004 may implement optical character recognition capabilities that may extend beyond basic text extraction to include handwriting recognition, document layout analysis, and multilingual text processing. The optical character recognition system may be configured to detect text elements within video frames, image content, or document-based materials and may convert these visual text elements into machine-readable format for subsequent semantic analysis.

In one or more embodiments, the semantic linking engine 1006 may incorporate advanced natural language processing techniques including named entity recognition, sentiment analysis, and topic modeling. The named entity recognition functionality may identify and classify entities such as persons, organizations, locations, dates, and objects across multiple content types. Sentiment analysis may determine emotional context or subjective opinions expressed within textual or audio content. Topic modeling may identify underlying thematic structures within large collections of content items.

In one or more embodiments, the semantic linking engine 1006 may generate confidence scores for identified relationships between content elements. These confidence scores may indicate the strength or reliability of detected semantic connections and may be used by the recommendation engine to prioritize content suggestions. The confidence scoring system may incorporate multiple factors including semantic similarity measures, temporal proximity of content elements, and user engagement patterns with related content.

In one or more embodiments, the timeline and relationship mapper 1008 may create dynamic visualizations that may adapt based on user interaction patterns and content analysis results. The timeline interface may support multiple viewing modes including chronological sequence, thematic clustering, and relationship network displays. Users may navigate between different temporal granularities ranging from detailed moment-by-moment analysis to broader time period overviews.

In one or more embodiments, the interactive query layer 1010 may implement natural language query processing that may allow users to input complex search requests using conversational language. The query processing system may parse user intent, identify key search parameters, and translate natural language queries into structured database searches across the semantic knowledge graph. The system may support both specific factual queries and exploratory browsing patterns.

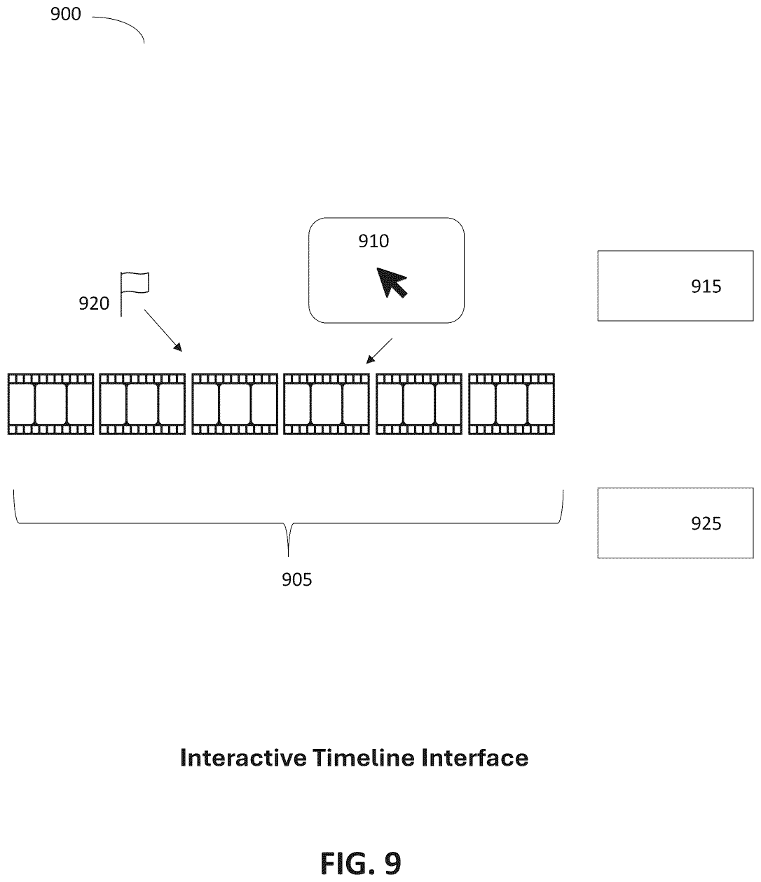

Referring to FIG. 9, an interactive timeline interface 900 may be utilized within the interactive content delivery system to provide users with comprehensive temporal navigation and content exploration capabilities. The interactive timeline interface 900 may serve as a primary user interface element that may enable users to navigate through chronologically organized content while accessing related materials and insights.

In one or more embodiments, the interactive timeline interface 900 may include a horizontal timeline 905 that may display events mapped along a temporal sequence. The horizontal timeline 905 may be represented as a filmstrip-like interface where individual frames or segments may correspond to specific temporal positions within the primary video content or related materials. Each segment of the horizontal timeline 905 may be associated with particular events, content elements, or interactive opportunities that may become available during video playback.

In one or more embodiments, the interactive timeline interface 900 may include clickable nodes 910 that may be linked to video segments, transcript excerpts, or photographs. The clickable nodes 910 may appear as interactive elements positioned along the horizontal timeline 905 that may respond to user input such as mouse clicks, touch gestures, or other selection methods. When a user may interact with a clickable node 910, the system may present associated content such as video clips, audio segments, textual excerpts, or photographic materials that may be contextually relevant to the selected temporal position.

In one or more embodiments, a panel for related insights 915 may be integrated within the interactive timeline interface 900. The panel for related insights 915 may be powered by the semantic linking engine and may display AI-generated recommendations, cross-references, or contextual information that may be relevant to the currently selected timeline position. The panel for related insights 915 may present content suggestions, related documents, or analytical insights that may enhance user understanding of the selected temporal segment.

In one or more embodiments, the interactive timeline interface 900 may include visual conflict indicators 920 that may identify potentially contradictory or inconsistent information within the content. The visual conflict indicators 920 may appear as flag icons, warning symbols, or other graphical elements that may be positioned at specific points along the horizontal timeline 905 where contradictions or discrepancies may have been detected by the AI analysis system. The visual conflict indicators 920 may utilize distinctive visual styling such as red coloring or warning symbols to draw user attention to potentially problematic content areas.

In one or more embodiments, a tooltip source citation window 925 may be accessible through the interactive timeline interface 900. The tooltip source citation window 925 may provide detailed source information, citations, or provenance data for content elements displayed within the timeline interface. When users may hover over or select specific timeline elements, the tooltip source citation window 925 may appear to display relevant citation information, source documentation, or attribution details that may support transparency and verification of the presented content.

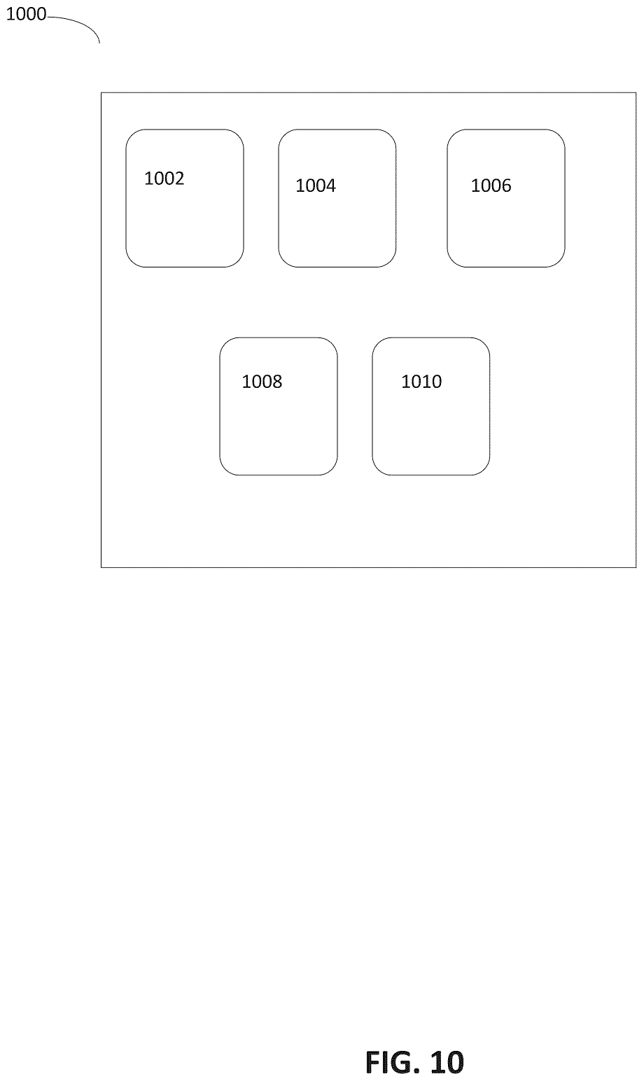

Referring to FIG. 10, a system architecture diagram 1000 may illustrate the modular components that may comprise the interactive content delivery system. The system architecture 1000 may include multiple interconnected modules that may work together to provide comprehensive content analysis and delivery capabilities.

In one or more embodiments, the system architecture 1000 may include a data ingestion module 1002 that may be configured to receive and process various types of digital content. The data ingestion module 1002 may handle multiple content formats including text documents, audio files, video files, and image files. The data ingestion module 1002 may perform initial content validation, format standardization, and metadata extraction to prepare content for subsequent processing stages.

In one or more embodiments, a processing module 1004 may be included within the system architecture 1000. The processing module 1004 may apply artificial intelligence models and machine learning algorithms to analyze ingested content. The processing module 1004 may perform operations such as natural language processing, speech-to-text conversion, optical character recognition, and automated content classification to extract meaningful features and information from the source materials.

In one or more embodiments, the system architecture 1000 may include a semantic linking engine 1006 that may identify relationships and connections between different content elements. The semantic linking engine 1006 may analyze processed content to detect recurring themes, related topics, named entities, and contextual associations that may exist across multiple content items. The semantic linking engine 1006 may generate cross-references and relationship mappings that may enable enhanced content discoverability and navigation.

In one or more embodiments, a timeline and relationship mapper 1008 may be incorporated within the system architecture 1000. The timeline and relationship mapper 1008 may organize content elements along temporal coordinates and may create visual representations of how entities, events, and themes may evolve over time. The timeline and relationship mapper 1008 may generate the underlying data structures that may support the interactive timeline interface functionality.

In one or more embodiments, an interactive query layer 1010 may be included within the system architecture 1000. The interactive query layer 1010 may provide user interface capabilities that may enable users to search, explore, and interact with the processed content. The interactive query layer 1010 may handle user queries, generate search results, and may coordinate the presentation of content recommendations and related materials through various interface elements.

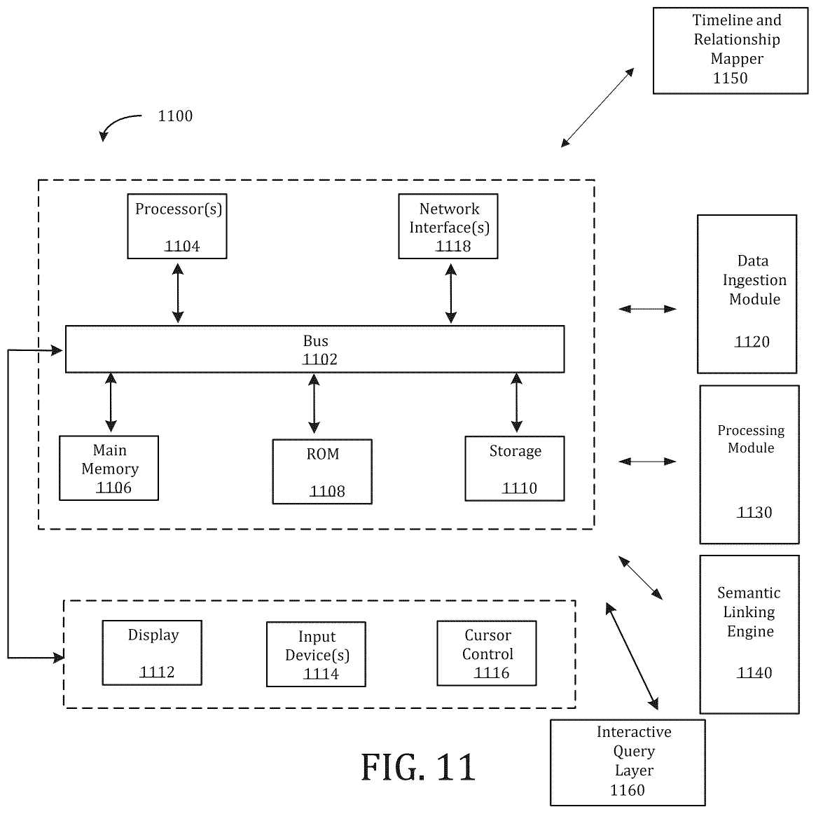

Referring to FIG. 11, a detailed system implementation 1100 may illustrate the hardware and software components that may support the interactive content delivery system. The system implementation 1100 may include both traditional computing hardware and specialized modules for content analysis and delivery.

In one or more embodiments, the system implementation 1100 may include one or more processors 1104 that may be operably coupled to a system bus 1102. The processors 1104 may include central processing units, graphics processing units, or specialized AI processing units that may be configured to execute the various computational tasks required for content analysis and delivery. The processors 1104 may be optimized for machine learning operations, computer vision processing, and real-time content analysis.

In one or more embodiments, main memory 1106 may be connected to the system bus 1102 and may provide high-speed storage for active data and program instructions. The main memory 1106 may store feature vectors, processing results, and temporary data structures that may be utilized during content analysis operations. Read-only memory 1108 may also be connected to the system bus 1102 and may contain firmware and system initialization code.

In one or more embodiments, storage 1110 may be connected to the system bus 1102 and may provide persistent storage for video content, interactive content items, user data, and system configurations. The storage 1110 may include solid-state drives, hard disk drives, or distributed storage systems that may accommodate large volumes of multimedia content and associated metadata.

In one or more embodiments, the system implementation 1100 may include a display 1112, input devices 1114, and cursor control 1116 that may enable user interaction with the system. The display 1112 may present the interactive timeline interface and other user interface elements. The input devices 1114 may include keyboards, touchscreens, or other input mechanisms that may allow users to interact with the system. Network interfaces 1118 may be connected to the system bus 1102 and may enable communication with external systems and remote devices.

In one or more embodiments, the system implementation 1100 may include specialized modules that may be connected to the core computing system. A data ingestion module 1120 may interface with the main system to receive and process incoming content. A processing module 1130 may apply AI models and analysis algorithms to the ingested content. A semantic linking engine 1140 may identify relationships and generate cross-references between content elements. A timeline and relationship mapper 1150 may organize content along temporal coordinates and may create timeline visualizations. An interactive query layer 1160 may provide user interface capabilities and may handle user interactions with the processed content.

In one or more embodiments, the system 100 may include a content curation interface that may enable manual oversight and enhancement of automated content analysis results. Content curators may access a director web application that may provide tools for reviewing AI-generated content relationships, adding editorial annotations, and configuring recommendation parameters. The curation interface may display confidence scores for automated suggestions and may allow curators to approve, modify, or reject system-generated content associations.

In one or more embodiments, the system 100 may implement persistent storage mechanisms for deferred interaction capabilities. The persistent storage system may maintain records of identified content relationships, user interaction patterns, and content recommendations even after primary content consumption has concluded. Users may return to the system at later times to explore previously identified content connections or to act upon stored recommendations.

In one or more embodiments, the system 100 may include external knowledge integration capabilities that may connect to third-party databases, reference materials, and information sources. The external knowledge integration may provide contextual information that may enhance content understanding and may enable contradiction detection by comparing content claims against established factual sources. The system may access legal databases, forensic science publications, medical literature, or other domain-specific knowledge sources as appropriate for the content being analyzed.

In one or more embodiments, the system 100 may implement user account management functionality that may track individual user preferences, engagement patterns, and content access history. The user account system may maintain personalized profiles that may influence content recommendations and may enable customized user experiences. User engagement scoring may quantify interaction levels with different content types and may be used to optimize future content delivery.

In one or more embodiments, the system 100 may support multi-device synchronization protocols that may coordinate content delivery across different user devices simultaneously. The synchronization system may maintain consistent playback positions, content states, and user interface elements across primary viewing devices and secondary interactive devices. The multi-device coordination may enable seamless transitions between devices and may support collaborative viewing experiences among multiple users.

In one or more embodiments, the system 100 may include notification and alert mechanisms that may inform users about relevant content discoveries, system updates, or interaction opportunities. The notification system may be configured to deliver alerts through multiple communication channels including in-application notifications, email messages, or mobile device push notifications. Notification timing and frequency may be customized based on user preferences and engagement patterns.

In one or more embodiments, the system 100 may implement content library management functionality that may allow users to organize, categorize, and retrieve saved content items. The library system may support user-defined collections, automated categorization based on content analysis results, and sharing capabilities that may enable users to distribute curated content collections to other system users.

In one or more embodiments, the system 100 may include audit trail and logging capabilities that may maintain comprehensive records of system operations, user interactions, and content analysis processes. The audit system may provide transparency regarding AI-generated insights and may enable traceability of content recommendations back to their source materials and analysis procedures. These audit capabilities may be particularly valuable in forensic or investigative applications where documentation of analysis methodology may be required.

In one or more embodiments, the system 100 may support integration with the SQUERL content management system and may implement specialized functionality including H.O.O.C.S. and H.O.O.K.S. components. H.O.O.C.S. may represent interactive content segments that may be accessible to users based on prerequisite knowledge acquisition or engagement criteria. H.O.O.K.S. may provide integration mechanisms that may connect streaming content with episode-specific group communications and may enable synchronized delivery of contextual information during content playback.

In one or more embodiments, the system 1000 may implement the Squerl AI Core Discovery System as a comprehensive multimedia content analysis and discovery platform. The Squerl AI Core Discovery System may comprise a data ingestion module 1002 that may be configured to receive and process digital content in multiple formats including text-based documents, audio files, video files, and images. The data ingestion module 1002 may support any suitable file format and may be configured to validate and normalize content formats during the ingestion process.

In one or more embodiments, the processing module 1004 may be configured to apply artificial intelligence models to perform operations including natural language processing, speech-to-text conversion, optical character recognition, and automated tagging or classification of visual and audio data. The processing module 1004 may implement computer vision models for scene classification, temporal action recognition, and multi-modal content understanding. The scene classification functionality may analyze visual elements within video content to identify environmental contexts such as indoor versus outdoor settings, urban versus rural environments, or specific location types.

In one or more embodiments, the processing module 1004 may implement optical character recognition capabilities that may extend beyond basic text extraction to include handwriting recognition, document layout analysis, and multilingual text processing. The optical character recognition system may be configured to detect text elements within video frames, image content, or document-based materials and may convert these visual text elements into machine-readable format for subsequent semantic analysis.

In one or more embodiments, the semantic linking engine 1006 may be configured to identify recurring or contextually related topics, keywords, dates, and named entities including people, locations, and objects across multiple ingested files. The semantic linking engine 1006 may generate semantic relationships or cross-references among such files and may incorporate advanced natural language processing techniques including named entity recognition, sentiment analysis, and topic modeling. The named entity recognition functionality may identify and classify entities such as persons, organizations, locations, dates, and objects across multiple content types.

In one or more embodiments, the semantic linking engine 1006 may generate confidence scores for identified relationships between content elements. These confidence scores may indicate the strength or reliability of detected semantic connections and may be used by the recommendation engine to prioritize content suggestions. The confidence scoring system may incorporate multiple factors including semantic similarity measures, temporal proximity of content elements, and user engagement patterns with related content.

In one or more embodiments, the timeline and relationship mapper 1008 may be configured to generate a visual or data-driven representation illustrating the occurrence, evolution, and interrelationships of entities, ideas, and themes over time or across source materials. The timeline and relationship mapper 1008 may create dynamic visualizations that may adapt based on user interaction patterns and content analysis results. The timeline interface may support multiple viewing modes including chronological sequence, thematic clustering, and relationship network displays.

In one or more embodiments, the interactive query layer 1010 may be configured to enable a user to search, explore, compare, and retrieve primary source materials that support, expand upon, or are otherwise contextually linked to a user query. The interactive query layer 1010 may implement natural language query processing that may allow users to input complex search requests using conversational language. The query processing system may parse user intent, identify key search parameters, and translate natural language queries into structured database searches across the semantic knowledge graph.

In one or more embodiments, the Squerl AI Core Discovery System may implement external knowledge integration capabilities that may connect to third-party databases, reference materials, and information sources. The external knowledge integration may provide contextual information that may enhance content understanding and may enable contradiction detection by comparing content claims against established factual sources. The system may access legal databases, forensic science publications, medical literature, or other domain-specific knowledge sources as appropriate for the content being analyzed.

In one or more embodiments, the Squerl AI Core Discovery System may support integration with the SQUERL content management system and may implement specialized functionality including H.O.O.C.S. and H.O.O.K.S. components. H.O.O.C.S. may represent interactive content segments that may be accessible to users based on prerequisite knowledge acquisition or engagement criteria. H.O.O.K.S. may provide integration mechanisms that may connect streaming content with episode-specific group communications and may enable synchronized delivery of contextual information during content playback.

In one or more embodiments, the Squerl AI Forensic Investigative Use Case may provide specialized functionality for forensic analysis, legal investigation, and public education applications. The forensic investigative system may implement timeline-linked file access functionality that may provide a user interface where all case materials including transcript lines, images, and recordings may be indexed and presented along a chronological timeline. Users may explore case events in temporal sequence or may reverse-engineer key developments across time periods.

In one or more embodiments, the forensic investigative system may implement cross-referencing capabilities that may automatically surface related documents, video stills, audio clips, or expert commentary when a user selects a specific moment or content element. The cross-referencing functionality may identify content that may support, address, or contradict the selected content and may present these relationships through the interactive interface.

In one or more embodiments, the forensic investigative system may incorporate external knowledge integration that may evaluate past claims against current legal, forensic, and medical standards. The system may determine whether recorded evidence or testimony may be consistent with modern scientific understanding and may flag potential discrepancies or inconsistencies. The external knowledge sources may include current legal databases, peer-reviewed forensic science publications, and medical literature.

In one or more embodiments, the forensic investigative system may implement contradiction and omission detection functionality that may scan entire datasets to identify inconsistencies, contradictions, or potentially exculpatory material that may have been missed or misunderstood in original investigations or legal processes. The contradiction detection system may use machine learning comparison models to identify discrepancies between contemporaneous records and modern standards.

In one or more embodiments, the forensic investigative system may provide transparent audit trail functionality where every AI-suggested connection, contradiction, or insight may be traceable back to source documents with citations and side-by-side displays to preserve context and transparency. The audit trail system may maintain comprehensive records of system operations, user interactions, and content analysis processes to provide transparency regarding AI-generated insights.

In one or more embodiments, the forensic investigative system may enable interactive timeline navigation that may be navigable by event type, speaker identity, or thematic tags. The timeline interface may include clickable nodes linked to video, transcript excerpts, or photographs and may provide panels for related insights powered by the Squerl AI system. Visual conflict indicators may highlight potential contradictions or inconsistencies within the timeline presentation.

In one or more embodiments, the forensic investigative system may support real-time user querying and dynamic content highlighting based on semantic similarity to selected phrases or document excerpts. AI-generated insights may be accompanied by confidence scoring and side-by-side visual comparison of linked documents to enable users to evaluate the reliability and relevance of system-generated recommendations.

In one or more embodiments, the forensic investigative system may be applicable to journalists, educators, policy reform advocates, students of law and forensics, and the general public for educational and civic engagement purposes. The system may provide comprehensive access to case materials and may enable users to explore historical legal cases with modern analytical tools and updated scientific standards.

In one or more embodiments, the forensic investigative system may implement persistent deferred interaction capabilities that may store detected relationships and entities so users may engage with content at later times beyond real-time consumption. Users may return to the system to explore previously identified content connections or to act upon stored recommendations while maintaining access to the complete audit trail of their investigative process.

In one or more embodiments, the system 100 may implement group communication features that may enable users to engage in discussions around specific content elements or temporal markers within video content. The group communication system may support both real-time chat during synchronized viewing sessions and asynchronous discussion threads associated with particular content segments. User grouping may be based on content access patterns, temporal viewing synchronization, or manually configured discussion groups.

In one or more embodiments, the system 100 may include e-commerce integration capabilities that may enable direct purchasing of products or merchandise identified within video content. The computer vision models may identify objects, products, or items appearing in video content and may generate purchasing recommendations or direct links to online retailers. The e-commerce integration may support transaction processing and may maintain records of user purchasing behavior for enhanced personalization of future product recommendations.

In one or more embodiments, the process may include generating at least one feature vector based at least on the first plurality of features. The feature vector may represent visual characteristics, objects, scenes, faces, actions, or any combination thereof identified in the video content. The feature vector may be generated using various machine learning techniques, including deep learning, neural networks, or other suitable algorithms. In one or more embodiments, the process may include providing the at least one feature vector to a machine learning model. The machine learning model may be configured to recommend at least one content item of the plurality of content items based at least on the at least one feature vector. The machine learning model may utilize collaborative filtering, content-based filtering, deep learning, or other suitable recommendation algorithms.

In one or more embodiments, during playback of the first video at a first user device 108, the process may include determining that the first playback position in the first video was reached. The system may monitor playback progress and synchronize content delivery based on specific temporal markers in the video content. In one or more embodiments, in response to determining that the first playback position in the first video was reached, the process may include causing the recommended at least one content item to be presented at a second user device 110. The first user device 108 may be different from the second user device 110, enabling a multi-device interactive experience.

In one or more embodiments, the process may include determining that the at least one content item is relevant to at least the first portion of the first video. Relevance may be determined based on feature matching, contextual analysis, user preferences, or any combination thereof. In one or more embodiments, the process may include providing at least a second portion of the first video to a first speech recognition model. The first speech recognition model may be configured to identify a second plurality of features in the first video based at least on the second portion of the first video. The second portion of the first video may be associated with at least the first playback position in the first video. Generating the at least one feature vector may include generating the at least one feature vector based at least on the first plurality of features and the second plurality of features, thereby combining visual and audio analysis.

In one or more embodiments, the process may include providing at least a second portion of the first video to the first computer vision model. The first computer vision model may be configured to determine that at least one item is depicted in the second portion of the first video and identify all playback positions in the first video during which the at least one item is depicted. This may enable comprehensive item tracking throughout the video content. In one or more embodiments, the process may include causing textual data determined to be relevant to the at least one item to be presented at the second user device 110. The textual data may provide additional context, information, or details about items appearing in the video content.

In one or more embodiments, the process may include determining that at least one second item is for sale on a first website and determining that a score indicating a similarity between the at least one item and the at least one second item meets a predetermined threshold. The process may include causing at least one link to purchase the at least one second item to be presented at the second user device 110. The process may include receiving a request to purchase the at least one second item from the second user device 110 and initiating a transaction for the purchase of the at least one second item by a user of the second user device 110.

In one or more embodiments, the system 100 may perform a process for interactive content delivery. The process may include storing a plurality of content items and receiving playback data indicating at least a first playback position in a first video. During playback of the first video at a first user device 108, the process may include determining that the first playback position in the first video was reached. In response to determining that the first playback position in the first video was reached, the process may include causing at least one content item of the plurality of content items to be presented at a second user device 110.

In one or more embodiments, the process may include sending a notification to the first user device 108 and/or the second user device 110. The notification may indicate that the at least one content item is being presented at the second user device 110. This may enhance user awareness of multi-device interactions and available content. In one or more embodiments, causing the at least one content item of the plurality of content items to be presented may include causing the at least one content item to be presented during playback of the first video at the first user device 108. This synchronization may provide a coordinated multi-device experience. In one or more embodiments, the process may include receiving, from the second user device 110, a request to download the at least one content item. In response to receiving the request to download the at least one content item, the process may include sending the at least one content item to the second user device 110. This may enable offline access to interactive content.

In one or more embodiments, the process may include storing the at least one content item in a library, receiving a selection of the at least one content item, and causing playback of the at least one content item. The library may provide organized access to previously encountered interactive content. In one or more embodiments, the process may include determining that a user of the second user device 110 interacted with the at least one content item and increasing a score of a user account associated with the user of the second user device 110. This gamification element may encourage user engagement with interactive content.

The foregoing description of various embodiments has been presented for purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

What is claimed is:

1. A system for AI-based interactive content delivery, comprising:
memory; and
one or more processors operably coupled to the memory, the one or more processors being configured to:
store a plurality of content items;
provide at least a first portion of a first video to a first computer vision model that is configured to identify a first plurality of features in the first video based at least on the first portion of the first video, wherein the first portion of the first video is associated with at least a first playback position in the first video;
generate at least one feature vector based at least on the first plurality of features;
provide the at least one feature vector to a machine learning model that is configured to recommend at least one content item of the plurality of content items based at least on the at least one feature vector;
during playback of the first video at a first user device, determine that the first playback position in the first video was reached; and
in response to determining that the first playback position in the first video was reached, cause the recommended at least one content item to be presented at a second user device, wherein the first user device is different from the second user device.

2. The system of claim 1, wherein the one or more processors are further configured to:
determine that the at least one content item is relevant to at least the first portion of the first video.

3. The system of claim 1, wherein the first computer vision model includes an image recognition model, a facial recognition model, or a combination thereof.

4. The system of claim 1, wherein the one or more processors are further configured to:
provide at least a second portion of the first video to a first speech recognition model that is configured to identify a second plurality of features in the first video based at least on the second portion of the first video, wherein the second portion of the first video is associated with at least the first playback position in the first video; and
generate the at least one feature vector based at least on the first plurality of features and the second plurality of features.

5. The system of claim 1, wherein the one or more processors are further configured to:
provide at least a second portion of the first video to the first computer vision model, wherein the first computer vision model is configured to:
determine that at least one item is depicted in the second portion of the first video; and
identify all playback positions in the first video during which the at least one item is depicted.

6. The system of claim 1, wherein the one or more processors are further configured to:
provide at least a second portion of the first video to the first computer vision model, wherein the first computer vision model is configured to determine that at least one item is depicted in the second portion of the first video; and
cause textual data determined to be relevant to the at least one item to be presented at the second user device.

7. The system of claim 1, wherein the one or more processors are further configured to:
provide at least a second portion of the first video to the first computer vision model, wherein the first computer vision model is configured to determine that at least one item is depicted in the second portion of the first video;
determine that at least one second item is for sale on a first website;
determine that a score indicating a similarity between the at least one item and the at least one second item meets a predetermined threshold;
cause at least one link to purchase the at least one second item to be presented at the second user device;
receive a request to purchase the at least one second item from the second user device; and
initiate a transaction for the purchase of the at least one second item by a user of the second user device.

8. A method for AI-based interactive content delivery, comprising:
storing a plurality of content items;
providing at least a first portion of a first video to a first computer vision model that is configured to identify a first plurality of features in the first video based at least on the first portion of the first video, wherein the first portion of the first video is associated with at least a first playback position in the first video;
generating at least one feature vector based at least on the first plurality of features;
providing the at least one feature vector to a machine learning model that is configured to recommend at least one content item of the plurality of content items based at least on the at least one feature vector;
during playback of the first video at a first user device, determining that the first playback position in the first video was reached; and
in response to determining that the first playback position in the first video was reached, causing the recommended at least one content item to be presented at a second user device, wherein the first user device is different from the second user device.

9. The method of claim 8, further comprising:
determining that the at least one content item is relevant to at least the first portion of the first video.

10. The method of claim 8, wherein the first computer vision model includes an image recognition model, a facial recognition model, or a combination thereof.

11. The method of claim 8, further comprising:
providing at least a second portion of the first video to a first speech recognition model that is configured to identify a second plurality of features in the first video based at least on the second portion of the first video, wherein the second portion of the first video is associated with at least the first playback position in the first video; and
generating the at least one feature vector based at least on the first plurality of features and the second plurality of features.

12. The method of claim 8, further comprising:
providing at least a second portion of the first video to the first computer vision model, wherein the first computer vision model is configured to:
determine that at least one item is depicted in the second portion of the first video; and
identify all playback positions in the first video during which the at least one item is depicted.

13. A non-transitory computer-readable medium comprising instructions that, when executed by one or more processors, cause the one or more processors to perform operations for AI-assisted interactive review of chronological multimedia datasets, the operations comprising:
ingesting multimedia content comprising transcripts, video, audio, and documents;
aligning each data element along a timeline interface;
providing a user interface configured to receive selection of a temporal marker and provide linked materials across all media types corresponding to that temporal marker;
integrating external knowledge sources to evaluate selected content in light of updated legal, forensic, and medical standards; and
displaying content relationships and inconsistencies identified by the system, with traceable citations to original files.

14. The non-transitory computer-readable medium of claim 13, wherein the external knowledge sources are selected from current legal databases, peer-reviewed forensic science publications, and medical literature.

15. The non-transitory computer-readable medium of claim 13, wherein the operations further comprise:
flagging discrepancies between contemporaneous records and modern standards using machine learning comparison models.

16. The non-transitory computer-readable medium of claim 13, wherein the timeline interface is navigable by event type, speaker identity, and thematic tags.

17. The non-transitory computer-readable medium of claim 13, wherein the operations further comprise:
receiving real-time user queries; and
providing dynamic content highlighting based on semantic similarity to a selected phrase and document excerpt.

18. The non-transitory computer-readable medium of claim 13, wherein AI-generated insights are accompanied by confidence scoring and side-by-side visual comparison of linked documents.

19. The non-transitory computer-readable medium of claim 13, wherein the operations further comprise:
sending a notification to the first user device, the second user device, or both, the notification indicating that the at least one content item is being presented at the second user device.

20. The non-transitory computer-readable medium of claim 13, wherein causing the at least one content item of the plurality of content items to be presented comprises causing the at least one content item to be presented during playback of the first video at the first user device.

21. The non-transitory computer-readable medium of claim 13, wherein the operations further comprise:
receiving, from the second user device, a request to download the at least one content item; and
in response to receiving the request to download the at least one content item, sending the at least one content item to the second user device.

22. The non-transitory computer-readable medium of claim 13, wherein the operations further comprise:
storing the at least one content item in a library;
receiving a selection of the at least one content item; and
causing playback of the at least one content item.

23. The non-transitory computer-readable medium of claim 13, wherein the operations further comprise:
determining that a user of the second user device interacted with the at least one content item; and
increasing a score of a user account associated with the user of the second user device.

24. The non-transitory computer-readable medium of claim 13, wherein the operations further comprise:
providing at least a first portion of the first video to a first computer vision model that is configured to identify a first plurality of features in the first video based at least on the first portion of the first video;
generating at least one feature vector based at least on the first plurality of features; and
providing the at least one feature vector to a machine learning model that is configured to recommend the at least one content item based at least on the at least one feature vector.

25. The non-transitory computer-readable medium of claim 19, wherein the first computer vision model comprises an image recognition model, a facial recognition model, an object detection model, and combinations thereof.
